(19) United States
(12) Patent Application Publication
(10) Pub. No.: US 2026/0179346 A1
(43) Pub. Date: Jun. 25, 2026

(54) METHOD AND SYSTEM FOR GENERATING GRASP MAP BASED ON OBJECT SEGMENTATION, AND LEARNING METHOD AND SYSTEM

(71) Applicant: GWANGJU INSTITUTE OF SCIENCE AND TECHNOLOGY, Gwangju (KR)

(72) Inventors: Kyoobin LEE, Gwangju (KR); Sang Jun NOH, Gwangju (KR); Jong Won KIM, Gwangju (KR); Rae Young KANG, Gwangju (KR); Dong Woo NAM, Gwangju (KR); Seung Hyeok BACK, Gwangju (KR)

(73) Assignee: GWANGJU INSTITUTE OF SCIENCE AND TECHNOLOGY, Gwangju (KR)

(21) Appl. No.: 19/366,752

(22) Filed: Oct. 23, 2025

(30) Foreign Application Priority Data
Dec. 19, 2024 (KR) 10-2024-0191306

(51) Int. Cl. G06V 10/26; G06V 10/77; G06V 10/774; G06V 20/60

(52) U.S. Cl. CPC G06V 10/26; G06V 10/7715; G06V 10/774; G06V 20/60

(57) ABSTRACT

Disclosed herein is a method for generating a grasp map including receiving a prompt generated to specify a target object together with an image obtained by capturing the target object, extracting a feature map corresponding to the image using an image encoder, inputting the prompt to a prompt encoder to generate a token for the target object determined to be grasped in the image, and inputting the feature map and the token to a mask decoder to generate a mask indicating an area corresponding to the target object in the image and a grasp map indicating an area where the target object is graspable.

### CROSS REFERENCE TO RELATED APPLICATION

The present application claims priority to Korean Patent Application No. 10-2024-0191306, filed Dec. 19, 2024, the entire contents of which are hereby incorporated by reference in its entirety.

### STATEMENT REGARDING PRIOR DISCLOSURES BY THE INVENTOR OR A JOINT INVENTOR

Prior disclosure related to the present application was made by inventors of the present application in journal paper entitled “GraspSAM: When Segment Anything Model Meets Grasp Detection” on Sep. 23, 2024. A copy of the journal paper is provided on a concurrently filed Information Disclosure Statement.

### BACKGROUND

### Field of the Invention

The disclosed embodiments relate to a method and system for generating a grasp map based on object segmentation, and a learning method and system.

### Description of the Related Art

A technology for estimating a grasp map is a technology that enables a robot to effectively identify various objects in a real environment, and is increasingly attracting interest in various fields. Conventionally, a grasp map was determined using shape information of a target object based on geometric analysis. To this end, a 3D model for the target object was required. Therefore, environmental variables such as surface irregularity, position change, and lighting change of the target object need to be sufficiently considered.

Meanwhile, as a technology for estimating a grasp map, a method has been proposed that may predict a grasp map more accurately by training the shape and surface characteristics of an object by utilizing a deep learning model that utilizes a deep neural network such as convolutional neural networks (CNN). The technology for estimating a grasp map based on deep learning was able to estimate a grasp map limited to a single object by training the single object, but a method that may process multiple objects simultaneously is gradually being studied. That is, the technology is performed by a method for identifying and classifying a target object through a separate network, and estimating a grasp map for the classified objects.

### SUMMARY

The disclosed embodiments are intended to provide a method and system for generating a grasp map based on object segmentation, and a learning method and system which can generate a grasp map for an untrained target object more accurately.

In addition, the disclosed embodiments are intended to provide a method and system for generating a grasp map based on object segmentation, and a learning method and system, which can omit a learning process that requires a complex and large amount of resources and perform an efficient adaptation process to effectively estimate a grasp map.

There is provided a method for generating a grasp map according to an embodiment. The method for generating a grasp map may include: receiving a prompt generated to specify a target object together with an image obtained by capturing the target object; extracting a feature map corresponding to the image using a pre-provided image encoder; inputting the prompt to a pre-provided prompt encoder to generate a token for the target object determined to be grasped in the image; and inputting the feature map and the token to a pre-provided mask decoder to generate a mask indicating an area corresponding to the target object in the image and a grasp map indicating an area where the target object is graspable.

There is provided a system for generating a grasp map according to an embodiment. The system for generation a grasp map may include: a storage unit that stores a prompt generated to specify a target object together with an image obtained by capturing the target object; a control unit that generates a grasp map corresponding to the image and the prompt using an image encoder, a prompt encoder, and a mask decoder, and the control unit extracts a feature map corresponding to the image using the image encoder, inputs the prompt to the prompt encoder to generate a token for the target object determined to be grasped in the image, and inputs the feature map and the token to the mask decoder to generate a mask indicating an area corresponding to the target object in the image and a grasp map indicating an area where the target object is graspable.

There is provided a program stored in a computer-readable recording medium according to an embodiment, executed by one or more processes in an electronic device, in which the program includes instructions to perform: receiving a prompt generated to specify a target object together with an image obtained by capturing the target object; extracting a feature map corresponding to the image using a pre-provided image encoder; inputting the prompt to a pre-provided prompt encoder to generate a token for the target object determined to be grasped in the image; and inputting the feature map and the token to a pre-provided mask decoder to generate a mask indicating an area corresponding to the target object in the image and a grasp map indicating an area where the target object is graspable.

There is provided a learning method according to an embodiment. The learning method may include: receiving a training image, a training prompt, and ground-truth data; extracting a training feature map corresponding to the training image using a pre-provided image encoder, and inputting the training prompt to a pre-provided prompt encoder to generate a training token for a target object determined to be grasped in the training image; inputting the training feature map and the training token to a pre-provided mask decoder to generate a training mask indicating an area corresponding to the target object in the training image and a training grasp map indicating an area where the target object is graspable; and comparing the ground-truth data, the training mask, and the training grasp map to calculate a loss function, and training at least one of the image encoder, the prompt encoder, and the mask decoder based on the loss function.

There is provided a learning system according to an embodiment. The learning system may include: a storage unit that stores a training image, a training prompt, and ground-truth data; and a control unit that trains at least one of an image encoder, a prompt encoder, and a mask decoder using the training image, the training prompt, and the ground-truth data, in which the control unit extracts a training feature map corresponding to the training image using the image encoder, inputs the training prompt to the prompt encoder to generate a training token for a target object determined to be grasped in the training image, inputs the training feature map and the training token to the mask decoder to generate a training mask indicating an area corresponding to the target object in the training image and a training grasp map indicating an area where the target object is graspable, compares the ground-truth data, the training mask, and the training grasp map to calculate a loss function, and trains at least one of the image encoder, the prompt encoder, and the mask decoder based on the loss function.

There is provided a program stored in a computer-readable recording medium according to an embodiment, executed by one or more processes in an electronic device, in which the program includes instructions to perform the following steps: receiving a training image, a training prompt, and ground-truth data; extracting a training feature map corresponding to the training image using a pre-provided image encoder, and inputting the training prompt to a pre-provided prompt encoder to generate a training token for a target object determined to be grasped in the training image; inputting the training feature map and the training token to a pre-provided mask decoder to generate a training mask indicating an area corresponding to the target object in the training image and a training grasp map indicating an area where the target object is graspable; and comparing the ground-truth data, the training mask, and the training grasp map to calculate a loss function, and training at least one of the image encoder, the prompt encoder, and the mask decoder based on the loss function.

According to the method and system for generating a grasp map based on object segmentation, and the learning method and system according to various embodiments of the present invention, by generating a grasp map for a target object based on an image and a prompt specifying the target object on the image, it is possible to generate the grasp map for the untrained target object more accurately.

In addition, the method and system for generating a grasp map based on object segmentation, and the learning method and system according to various embodiments of the present invention, by equipping the encoder and decoder pre-trained based on the large-scale training data with modules such as the learnable adapter and the multi-perceptron layer to train only the corresponding modules, it is possible to omit the complex and resource-intensive learning process and effectively perform the adaptation process to effectively perform the grasp map estimation.

### BRIEF DESCRIPTION OF THE DRAWINGS

FIG. 1 illustrates an embodiment of a system for generating a grasp map according to the present invention.

FIG. 2 illustrates a learning system according to the present invention.

FIG. 3 illustrates the system for generating a grasp map according to the present invention.

FIG. 4 is a flowchart illustrating a learning method according to the present invention.

FIG. 5 illustrates an embodiment of training an image encoder and a prompt encoder.

FIG. 6 is a flowchart illustrating a method for generating a grasp map according to the present invention.

FIG. 7 illustrates an embodiment of generating a feature map.

FIG. 8 illustrates an embodiment of generating a token.

FIG. 9 illustrates an embodiment of generating a mask and a grasp map.

FIG. 10 is a block diagram illustrating an embodiment of a computing system in which the present invention may be implemented.

FIGS. 11 and 12 are block diagrams illustrating an embodiment of a computing device according to the present invention.

### DETAILED DESCRIPTION OF THE INVENTION

Hereafter, embodiments described in the present specification will be described in detail with reference to the accompanying drawings and the same or similar components are given the same reference numerals regardless of reference numerals and are not repeatedly described. In addition, terms “module” and “unit” for components used in the following description are used only to easily make the disclosure. Therefore, these terms do not have meanings or roles that distinguish from each other in themselves. Further, in describing the embodiments disclosed in the present specification, when it is determined that a detailed description for the known art related to the present invention may obscure the gist of the embodiments described in the present specification, the detailed description will be omitted. Further, it should be understood that the accompanying drawings are provided only in order to allow the embodiments described in the present specification to be easily understood, and the spirit of the present invention is not limited by the accompanying drawings, but includes all the modifications, equivalents, and substitutions included in the spirit and the scope of the present invention.

Terms including ordinal numbers such as “first,” “second,” etc., may be used to describe various components, but the components are not to be construed as being limited to the terms. The terms are only used to differentiate one component from other components.

It is to be understood that, when a component is referred to as being “connected to” or “coupled to” another component, it may be connected directly to or coupled directly to another element or be connected to or coupled to another element, having other components intervening therebetween. On the other hand, it should be understood that when one component is referred to as being “connected directly to” or “coupled directly to” another component, it may be connected to or coupled to another component without other components interposed therebetween.

Singular expressions are intended to include plural expressions unless the context clearly indicates otherwise.

It will be further understood that terms “include” or “have” used in the present specification specify the presence of features, numerals, steps, operations, components, parts mentioned in the present specification, or combinations thereof, but do not preclude the presence or addition of one or more other features, numerals, steps, operations, components, parts, or combinations thereof.

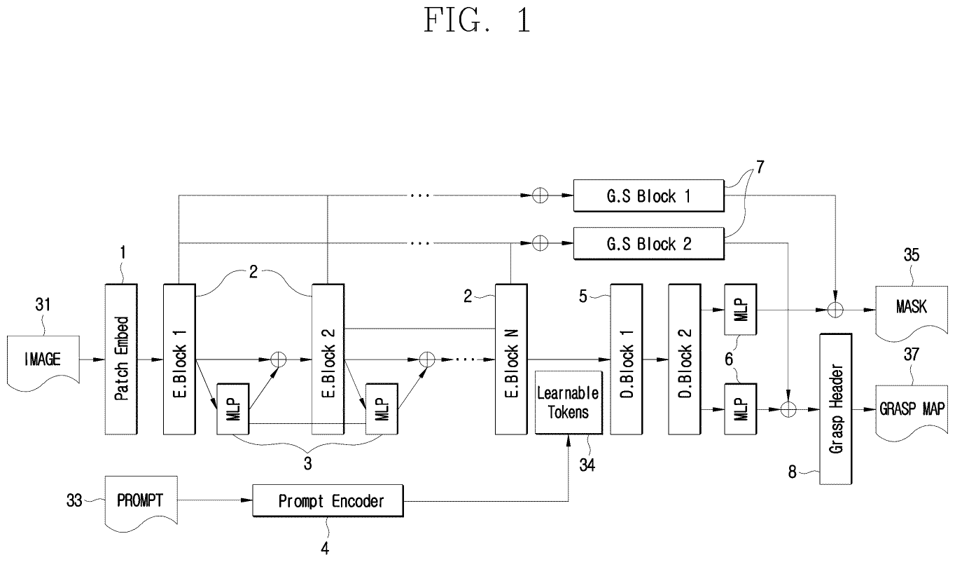

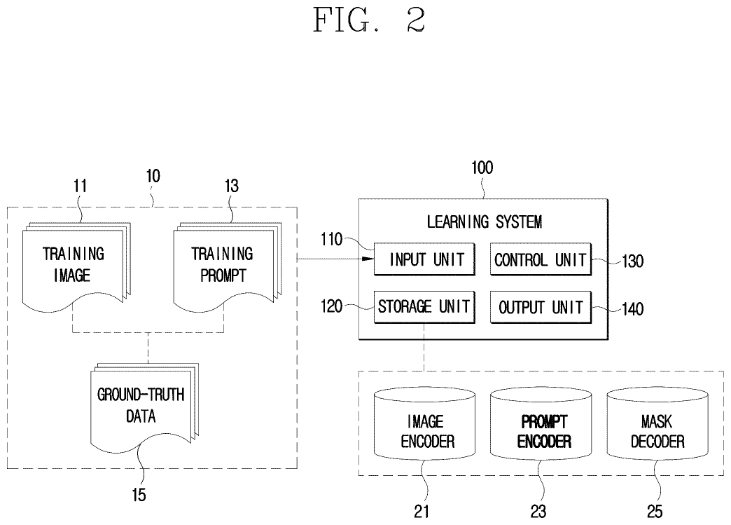

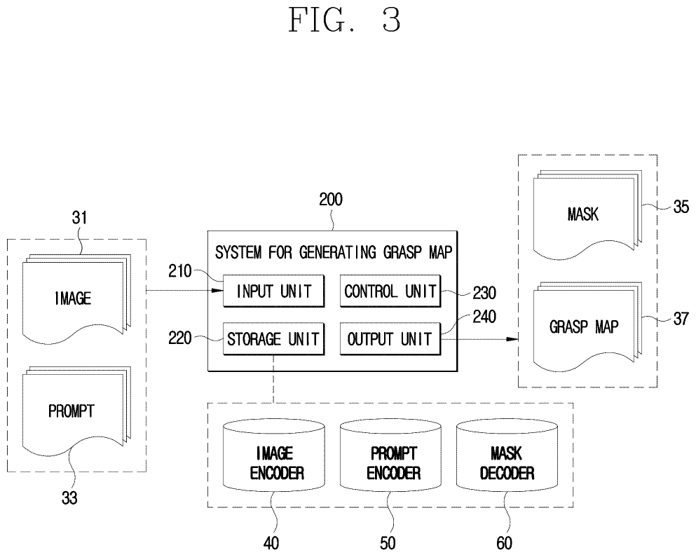

FIG. 1 illustrates an embodiment of a system for generating a grasp map according to the present invention. FIG. 2 illustrates a learning system according to the present invention. FIG. 3 illustrates the system for generating a grasp map according to the present invention.

Referring to FIG. 1, when receiving a prompt 33 generated to specify a target object together with an image 31 obtained by capturing the target object, a system 200 for generating a grasp map according to the present invention may input the image 31 to the image encoder to generate a feature map, input the prompt 33 to a prompt encoder 4 to generate a token 34, and input the feature map and the token 34 to a mask decoder to generate a grasp map 37 for the target object.

Here, the target object may be an item provided to be grasped by a gripper provided on a control device such as a robot, allowing the object to be moved to a different location or to perform specific interactions. The target object may encompass a wide range of objects, from small to medium-sized items used in daily life to large objects utilized in specific professional fields such as industry or commerce.

That is, the target object may vary depending on the form of a robot, etc., which is provided to grasp the target object, but it may be understood that this specification is not limited to the type or shape of the target object.

Meanwhile, the image 31 may be a target object captured using a camera, an imaging device, etc. The image 31 may be a target object captured, or two or more target objects captured. In addition, the image 31 may include a plurality of pixels having RGB values, and the color values of each of the plurality of pixels may be configured in a format other than RGB.

The prompt 33 may include information indicating the target object to be grasped in the image 31. The prompt 33 may be generated based on user input. According to an embodiment, the prompt 33 may be generated in the form of the voice and text, or may be generated to include information on one or more pixels selected from the image 31 based on the user input. That is, the prompt 33 may include information in the form of the voice and text indicating the type, color, shape, etc., of the target object, include information in the form of a bounding box set on the image 31 based on the user input or a polygonal box according to polygon labeling, or include information in the form of a point set on the image 31 based on the user input.

Meanwhile, the image encoder may be implemented (or trained) to analyze visual features from the image 31 and generate the feature map corresponding to the corresponding image 31. In an embodiment, the image encoder may be implemented based on a vision transformer (ViT). Such an image encoder may be pre-trained based on large-scale training data to extract the feature map from the image 31.

Therefore, when the image 31 is input, the image encoder segments the previously input image 31 into image patches of a predetermined size and converts each segmented image patch into a feature vector, thereby generating the feature map corresponding to the image 31. That is, the feature map generated from the image encoder may include a plurality of feature vectors corresponding to each of the plurality of image patches segmented from the image 31.

In addition, the image encoder may be provided so that a plurality of encoder blocks 2 that generate feature maps of multiple scales are connected according to an embodiment. In this case, an adapter 3 may be provided between the plurality of encoder blocks 2 (or an output terminal of each image encoder). Accordingly, each encoder block 2 may be implemented to input a synthesized feature map in which the feature map generated from the previous encoder block and an adaptive feature map generated from the adapter 3 are synthesized, and generate a new feature map corresponding to the input synthesized feature map.

In this case, the adapter 3 may be composed of learnable parameters, and furthermore, the adapter 3 may be implemented in the form of a multi-layer perceptron (MLP). In an embodiment, the adapter 3 may be a Rein adapter.

Therefore, the adapter 3 may be trained according to the learning method to be described below. In this case, the adapter 3 may be trained by the learning system 100 according to the present invention. In addition, the encoder block 2, in which the adapter 3 is provided, may have been pre-trained through a separate system. That is, it may be understood that the encoder block 2 is not trained separately while training the adapter 3.

In an embodiment, the image encoder may be represented as in Equation 1 below, and the adapter 3 may be represented as in Equation 2 below.

$${f}_{1} = {B}_{1} ( P . E ( x ) ) , {f}_{1} ∈ {R}^{n \times c} \qquad [ Equation 1 ]$$

$${f}_{i + 1} = {B}_{i + 1} ( {f}_{i} + ) , i = 1 , 2 , … , N - 1$$

$${f}_{out} = {f}_{N} +$$

Here, Bᵢ may represent an i-th encoder block 2 of the image encoder, fᵢ may represent the feature map generated from the i-th encoder block 2, \hat{f}ᵢ may represent the feature map generated from the adapter 3 provided in the i-th encoder block 2, and fₒᵤₜ may represent the feature map output from the image encoder.

In addition, RE may represent an embedding block 1 (e.g., Patch Embad) implemented to segment the image 31 into the image patches having the predetermined size, n may represent the number of image patches, and c may represent an embedding dimension of a first feature map.

$$= Ad ( {f}_{i} ) , {f}_{i} ∈ {R}^{n \times \hat{c}} , i = 1 , 2 , … , N - 1 \qquad [ Equation 2 ]$$

Here, Ad may represent the adapter 3, and ĉ may represent an embedding dimension of the i-th feature map.

In addition, the prompt encoder 4 may be implemented (or trained) to analyze the image 31 using the prompt 33 generated based on the user input, and generate the token 34 based on the analysis result. In this case, the token 34 is a learnable token, and may include information on a target object determined to be grasped in the image 31 based on the user input (or the prompt 33), and may be generated, for example, in the form of a parameter corresponding to an area (or the target object) selected from the image 31 based on the prompt 33.

To this end, when the prompt 33 (and the image 31) is input, the prompt encoder 4 may be trained to generate the bounding box (or a polygonal box) for the target object based on the prompt 33, and generate the feature vector for the image area corresponding to the previously generated bounding box as the token 34.

In this way, the prompt encoder 4 may be trained according to the learning method to be described below. In this case, the prompt encoder 4 may be trained by the learning system 100 according to the present invention. In addition, according to an embodiment, the prompt encoder 4 may have been pre-trained. In this case, the prompt encoder 4 may be understood as having been trained through a separate system.

Meanwhile, the mask decoder may analyze the feature map generated from the image 31 and the token 34 generated from the prompt 33 together to generate a mask 35 and the grasp map 37. In this case, the mask 35 includes information on an area where the target object exists in the image 31, and the grasp map 37 may include information on the angle and width of the gripper that can grasp the target object according to the mask 35.

To this end, the mask decoder may include a plurality of decoder blocks 5, a feature map fusion block 7, a multi-perceptron layer 6, and a grasp header 8. Accordingly, the mask decoder may be implemented so that when the feature map is generated from the image encoder and the token 34 is generated from the prompt encoder 4, the feature map and the token 34 are input to the plurality of decoder blocks 5, and data output from the plurality of decoder blocks 5 are input to the multi-perceptron layer 6.

In addition, the mask decoder may be implemented so that multi-scale feature maps generated based on the plurality of encoder blocks 5 are synthesized and input to the feature map fusion block 7, and data output from the feature map fusion block 7 and data output from the multi-perceptron layer 6 are synthesized to generate the mask 35 corresponding to the target object.

In addition, the mask decoder may be implemented so that the previously generated mask 35 is input to the grasp header 8 to generate the grasp map 37 corresponding to the target object. In this case, the grasp header 8 may include a mask header, an identification reliability header, a gripper angle header, and a gripper width header, and each header may include learnable parameters.

Therefore, the mask header may be trained to generate the mask 35 for the area corresponding to the target object based on the image 31 and the token 34, the identification reliability header may be trained to estimate the reliability of the mask 35 generated from the mask header, the gripper angle header may be trained to estimate the angle of the gripper that is graspable for the target object, and the gripper width header may be trained to estimate the width of the gripper that is graspable for the target object.

In this regard, the plurality of decoder blocks 5 may be pre-trained based on the large-scale training data, and may be implemented so that a feature map generated from a last encoder block of the image encoder and the token 34 generated from the prompt encoder 4 are input to a first decoder block, and data generated from a previous decoder block are input to other decoder blocks.

Meanwhile, the feature map fusion block 7, the multi-perceptron layer 6, and the grasp header 8 may be trained according to the learning method described below. In this case, the feature map fusion block 7, the multi-perceptron layer 6, and the grasp header 8 may be trained by the learning system 100 according to the present invention. In addition, the decoder block 5 may be pre-trained through a separate system. That is, it may be understood that the decoder block 5 is not trained separately while training the feature map fusion block 7, the multi-perceptron layer 6, and the grasp header 8.

In addition, the feature map fusion block 7, the multi-perceptron layer 6, and the grasp header 8 that are included in the mask decoder, and the adapter 3 that is included in the image encoder may be trained together, or the feature map fusion block 7, the multi-perceptron layer 6, the grasp header 8, and the adapter 3 may be trained independently of each other, or may be trained sequentially in a predetermined order.

Referring to FIG. 2, for example, the learning system 100 may train the adapter that is included in an image encoder 21, and the feature map fusion block, the multi-perceptron layer, and the grasp header that are included in a mask decoder 25 by using training data 10 composed of a training image 11, a training prompt 13, and ground-truth data 15. In this case, the ground-truth data 15 may refer to a target output value (label or target value) that the model is intended to predict for the corresponding input data.

Here, the training prompt 13 may be a prompt provided to correspond to the training image 11, and the ground-truth data 15 may include a ground-truth mask and a ground-truth grasp map for the target object provided to correspond to the training image 11 and the training prompt 13. In this case, the ground-truth grasp map may include a gripper angle and a gripper width for grasping the target object according to the ground-truth mask. That is, the ground-truth data 15 may include the ground-truth mask and the ground-truth grasp map labeled in the training image 11 and the training prompt 13.

Accordingly, the learning system 100 may input the training image 11 to the image encoder 21 to generate the feature map, input the training prompt 13 to the prompt encoder 23 to generate the token, and input the feature map and the token to the mask decoder 25 to generate a training mask and a training grasp map.

Through this, the learning system 100 may compare the training mask and the ground-truth mask to calculate a mask loss, and compare the training grasp map and the ground-truth grasp map to calculate a grasp loss. In addition, the learning system 100 may calculate (or define) a loss function by adding up the previously calculated mask loss and grasp loss, and may train the feature map fusion block, the multi-perceptron layer, the grasp header, and the adapter based on this loss function.

In an embodiment, the learning system 100 may define the loss function according to the following Equation 3.

$$L = {λ}_{1} * {L}_{mask} + {λ}_{2} * {L}_{grasp} \qquad [ Equation 3 ]$$

Here, Lₘₐₛₖ may represent the mask loss, L_{grasp} may represent the grasp loss, k₁ may represent a hyper parameter or a weight (e.g., 2) determined in advance for the mask loss, and k₂ may represent a hyper parameter or a weight (e.g., 1) determined in advance for the grasp loss.

That is, the learning system 100 may assign weights to each of the mask loss and grasp loss to calculate the loss function, but may assign a greater weight to the mask loss than to the grasp loss.

Meanwhile, the learning system 100 may also calculate the grasp loss based on the training mask (or the ground-truth mask). In this case, the learning system 100 may assign weights to a loss calculated for an area corresponding to the training mask and a loss calculated for an area not corresponding to the training mask, respectively, in the grasp map to calculate the grasp loss. In this case, the learning system 100 may assign a greater weight to the area corresponding to the training mask than to the area not corresponding to the training mask.

In an embodiment, the learning system 100 may calculate (or define) the grasp loss according to the following Equation 4.

$${L}_{grasp} = {λ}_{3} * {L}_{fore} + {λ}_{4} * {L}_{back} \qquad [ Equation 4 ]$$

Here, L_{fore} may represent the loss calculated for the area corresponding to the training mask in the grasp map, L_{back} may represent the loss calculated for the area not corresponding to the training mask in the grasp map, λ₃ may represent the hyper parameter or the weight (e.g., 1) determined in advance for the loss of the area corresponding to the training mask, and λ₄ may represent a hyper parameter or a weight (e.g., 0.01) determined in advance for the loss of the area corresponding to the training mask.

In this regard, the learning system 100 according to the present invention may include an input unit 110, a storage unit 120, a control unit 130, and an output unit 140.

The input unit 110 may input information necessary for the operation of the learning system 100 according to the present invention. To this end, the input unit 110 may be connected to a separate input device, a server, an external storage device, etc., via a wireless or wired network.

Therefore, the input unit 110 may receive the training data 10 (e.g., the training image 11, the training prompt 13, and the ground-truth data 15) from a separate input device, a server, an external storage device, etc.

In addition, the input unit 110 may receive the user input required to train at least one of the image encoder 21, the prompt encoder 23, and the mask decoder 25 based on the training data 10.

In addition, the storage unit 120 may store instructions and information necessary for the operation of the learning system 100 according to the present invention. For example, the storage unit 120 may store the training data 10 input through the input unit 110. In addition, the storage unit 120 may store the image encoder 21, the prompt encoder 23, and the mask decoder 25.

In addition, the storage unit 120 may store various data generated while training at least one of the image encoder 21, the prompt encoder 23, and the mask decoder 25.

The control unit 130 may control the overall operation of the learning system 100 according to the present invention. That is, the control unit 130 may train the adapter that is included in the image encoder 21, and the feature map fusion block, the multi-perceptron layer, and the grasp header that are included in the mask decoder 25 by using the training data 10 composed of the training image 11, the training prompt 13, and the ground-truth data 15.

Specifically, the control unit 130 may receive the training image 11, the training prompt 13, and the ground-truth data 15, extract a training feature map corresponding to the training image 11 using the pre-provided image encoder 21, and input the training prompt 13 to the pre-provided prompt encoder 23 to generate the training token for the target object determined to be grasped in the training image 11.

To this end, the control unit 130 may input the training image 11 to the image encoder 21 composed of a plurality of pre-trained encoder blocks and an adapter provided in each of the plurality of encoder blocks to extract the training feature map.

In addition, the control unit 130 may input the training prompt 13 generated to specify the target object in the training image 11 to the pre-provided prompt encoder 23 to generate a training token indicating an area where the target object is located in the training image 11.

Accordingly, the control unit 130 may input the training feature map and the training token to the pre-provided mask decoder 25 to generate the training mask indicating the area corresponding to the target object in the training image 11 and the training grasp map indicating the area where the target object may be grasped.

That is, the control unit 130 may input the training feature map generated from the image encoder 21 and the training token generated from the prompt encoder 23 to the mask decoder 25 composed of the plurality of pre-trained decoder blocks, the feature map fusion block, the multi-perceptron layer, and the grasp header to generate the training mask and the training grasp map.

Furthermore, the control unit 130 may compare the ground-truth data 15 with the training mask and the training grasp map to calculate the loss function, and train at least one of the image encoder 21, the prompt encoder 23, and the mask decoder 25 based on the loss function.

To this end, the control unit 130 may compare the ground-truth mask included in the ground-truth data 15 with the training mask to calculate the mask loss, compare the ground-truth grasp map included in the ground-truth data 15 with the training grasp map to calculate the grasp loss, add up the mask loss and the grasp loss to calculate the loss function, and train at least one of the image encoder 21, the prompt encoder 23, and the mask decoder 25 based on the calculated loss function.

In this case, the control unit 130 may fix the parameters of the plurality of encoder blocks, for the image encoder 21 composed of the plurality of encoder blocks and the adapter provided in each of the plurality of encoder blocks, train the adapter based on the previously calculated loss function, fix the parameters of the plurality of decoder blocks, for the mask decoder 25 composed of the plurality of decoder blocks, the feature map fusion block, the multi-perceptron layer, and the grasp header, and train the feature map fusion block, the multi-perceptron layer, and the grasp header based on the previously calculated loss function.

The output unit 140 may output information generated by the operation of the learning system 100 according to the present invention. To this end, the output unit 140 may be connected to a separate visual output device, a server, an external storage device, etc., via a wireless or wired network.

Therefore, the output unit 140 may output the training data 10 and various data generated while training at least one of the image encoder 21, the prompt encoder 23, and the mask decoder 25 so that the user can visually confirm the training data 10 and various data through the separate output device, the server, or the external storage device. According to an embodiment, the output unit 140 may transmit, to other devices, the training data 10 and various data generated while training at least one of the image encoder 21, the prompt encoder 23, and the mask decoder 25.

Meanwhile, referring to FIG. 3, the system 200 for generating a grasp map according to the present invention may include an input unit 210, a storage unit 220, a control unit 230, and an output unit 240.

The information necessary for the operation of the system 200 for generating a grasp map according to the present invention may be input to the input unit 210. To this end, the input unit 210 may be connected to the separate input device, the server, the external storage device, etc., via the wireless or wired network.

Therefore, the input unit 210 may receive the image 31 and the prompt 33 from the separate input device, the server, the external storage device, etc. In this case, the input unit 210 may receive the user input for generating the prompt 33, and the input unit 210 may also receive the user input required while generating the grasp map 37 for the target object based on the image 31 and the prompt 33.

In addition, the storage unit 220 may store instructions and information required for the operation of the system 200 for generating a grasp map according to the present invention. For example, the storage unit 220 may store the image 31 and the prompt 33 input through the input unit 210. In addition, the storage unit 220 may store an image encoder 40, a prompt encoder 50, and a mask decoder 60.

In addition, the storage unit 220 may store various data generated while generating the grasp map 37 using the image encoder 40, the prompt encoder 50, and the mask decoder 60.

The control unit 230 may control the overall operation of the system 200 for generating a grasp map according to the present invention. That is, the control unit 230 may receive the prompt 33 generated to specify the target object together with the image 31 obtained by capturing the target object, input the image 31 to an image encoder 40 to generate the feature map, input the prompt 33 to a prompt encoder 50 to generate the token, and input the feature map and the token to a mask decoder 60 to generate the grasp map 37 for the target object.

Specifically, the control unit 230 may receive the prompt 33 generated to specify the target object together with the image 31 obtained by capturing the target object. In this case, the control unit 230 may receive the prompt 33 generated to specify the target object in the image 31 according to the user input together with the image 31.

Accordingly, the control unit 230 may extract the feature map corresponding to the image 31 using the pre-provided image encoder 40. To this end, the control unit 230 may input the image 31 to the image encoder 40 composed of the plurality of encoder blocks and the adapter provided in each of the plurality of encoder blocks to extract the feature map.

In addition, the control unit 230 may input the prompt 33 to the pre-provided prompt encoder 50 to generate the token for the target object determined to be grasped in the image 31. To this end, the control unit 230 may input, to the pre-provided prompt encoder 50, the prompt 33 generated to specify the target object in the image 31 according to the user input to generate the token indicating the area where the target object is located in the image 31.

Furthermore, the control unit 230 may input the feature map and the token to the pre-provided mask decoder 60 to generate the mask 35 indicating the area corresponding to the target object in the image 31 and the grasp map 37 indicating the area where the target object is graspable.

That is, the control unit 230 may input the feature map generated from the image encoder 40 and the token generated from the prompt encoder 50 to the mask decoder 60 composed of the plurality of decoder blocks, the feature map fusion block, the multi-perceptron layer, and the grasp header to generate the mask 35 and the grasp map 37.

The output unit 240 may output the information generated by the operation of the system 200 for generating a grasp map according to the present invention. To this end, the output unit 240 may be connected to the separate visual output device, the server, the external storage device, etc., via the wireless or wired network.

Therefore, the output unit 240 may output the image 31 and the prompt 33 and various data generated while generating the mask 35 and the grasp map 37 using the image encoder 40, the prompt encoder 50, and the mask decoder 60 so that the user may visually confirm the image 31 and the prompt 33 and various data through the separate output device, the server, the external storage device, etc. According to an embodiment, the output unit 240 may transmit the image 31 and the prompt 33 and various data generated while generating the mask 35 and the grasp map 37 using the image encoder 40, the prompt encoder 50, and the mask decoder 60 to other devices.

A learning method and a method for generating a grasp map will be described in more detail below based on the configuration of the learning system 100 and the system 200 for generating a grasp map described above.

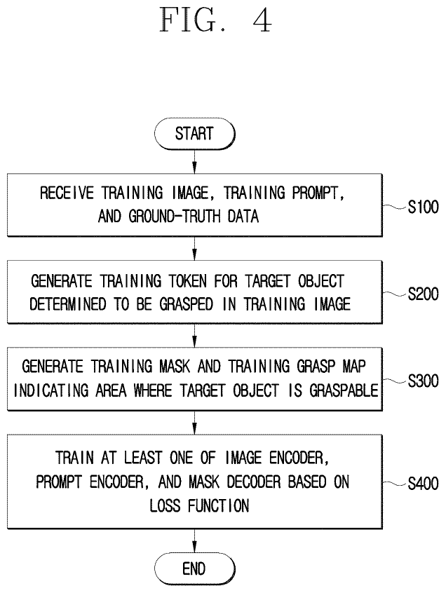

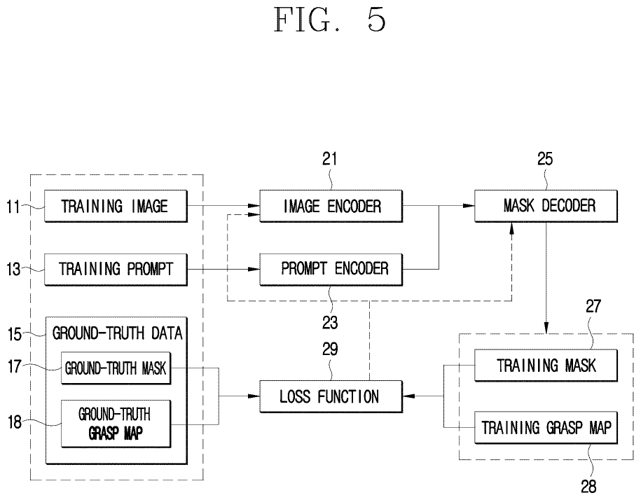

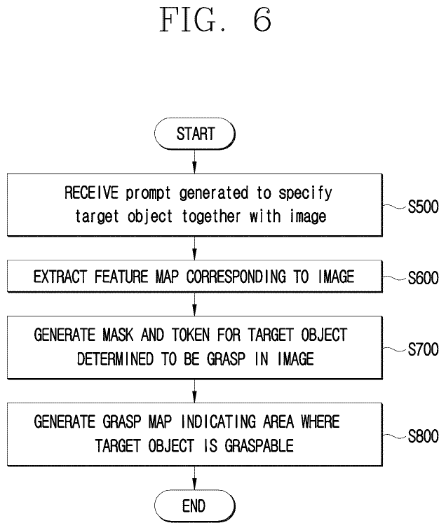

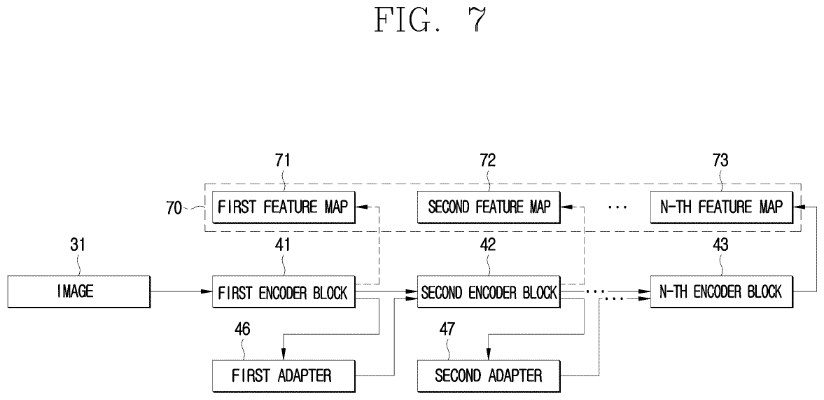

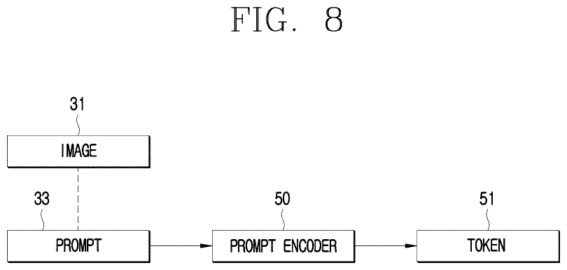

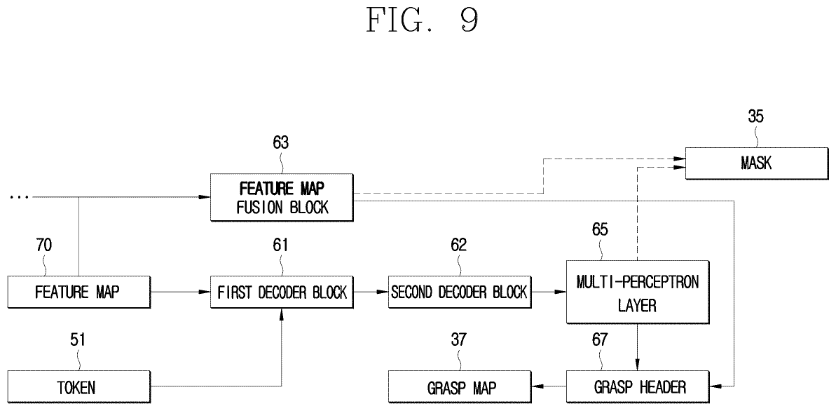

FIG. 4 is a flowchart illustrating a learning method according to the present invention. FIG. 5 illustrates an embodiment of training an image encoder and a prompt encoder. FIG. 6 is a flowchart illustrating a method for generating a grasp map according to the present invention. FIG. 7 illustrates an embodiment of generating a feature map. FIG. 8 illustrates an embodiment of generating a token. FIG. 9 illustrates an embodiment of generating a mask and a grasp map.

Referring to FIG. 4, the learning system 100 according to the present invention may receive the training image, the training prompt, and the ground-truth data (S100), extract the training feature map corresponding to the training image using the pre-provided image encoder, and input the training prompt to the pre-provided prompt encoder to generate the training token for the target object determined to be grasped in the training image (S200).

Specifically, the learning system 100 may input the training image to the image encoder composed of the plurality of pre-trained encoder blocks and the adapter provided in each of the plurality of encoder blocks to extract the training feature map.

For example, the learning system 100 may segment the training image into the image patches of the predetermined size and input the segmented training image to a first encoder block to generate a first training feature map. In addition, the learning system 100 may input the first training feature map to the first adapter provided in the first encoder block to generate a first training adapter feature map.

Accordingly, the learning system 100 may synthesize (or connect) the first training feature map and the first training adapter feature map to generate a first training synthesized feature map, and input the first training synthesized feature map to a second encoder block to generate a second training feature map. In addition, the learning system 100 may input the second training feature map to a second adapter provided in the second encoder block to generate a second training adapter feature map.

Therefore, the learning system 100 may synthesize (or connect) the second training feature map and the second training adapter feature map to generate a second training synthesized feature map, and may repeat the process of generating the training feature map through the plurality of encoder blocks provided in the image encoder and the adapter provided in each encoder block to generate a multi-scale training feature map.

In this case, the plurality of training feature maps corresponding to the multi-scale training feature map may include the training feature maps output from the plurality of encoder blocks, and the final training feature map output from the image encoder may be the training feature map output from the last encoder block among the plurality of encoder blocks.

Furthermore, the learning system 100 may input, to the pre-provided prompt encoder, the training prompt generated to specify the target object in the training image, and generate the training token indicating the area where the target object is located in the training image.

For example, the learning system 100 may input the training prompt generated in the form of a point corresponding to the training image to the prompt encoder. In this case, the learning system 100 may generate the bounding box (or the polygonal box) representing the area of the target object based on the location where the training prompt is designated on the training image through the prompt encoder, and generate the previously generated bounding box (or the parameter into which the bounding box is converted) as the training token.

For another example, the learning system 100 may input the training prompt generated in the form of the voice or text corresponding to the training image to the prompt encoder. In this case, the learning system 100 may generate the bounding box (or the polygonal box) representing the area of the target object on the training image based on the training prompt through the prompt encoder, and generate the previously generated bounding box (or the parameter into which the bounding box is converted) as the training token.

For another example, the learning system 100 may input the training prompt generated in the form of the bounding box or the polygonal box corresponding to the training image to the prompt encoder. In this case, the learning system 100 may convert the training prompt into the parameter (or, learnable token) form through the prompt encoder to generate the training token.

The learning system 100 according to the present invention may input the training feature map and the training token to the pre-provided mask decoder to generate the training mask indicating the area corresponding to the target object in the training image and the training grasp map indicating the area where the target object is graspable (S300).

Specifically, the learning system 100 may input the training feature map generated from the image encoder and the training token generated from the prompt encoder to the mask decoder composed of the plurality of pre-trained decoder blocks, the feature map fusion block, the multi-perceptron layer, and the grasp header to generate the training mask and the training grasp map.

For example, the learning system 100 may input the training feature map generated from the last encoder block among the plurality of encoder blocks included in the image encoder and the training token generated from the prompt encoder to the first decoder block, and input the data output from the first decoder block into the second decoder block.

Accordingly, the learning system 100 may repeat the process of inputting the data output from the previous decoder block to each of the plurality of decoder blocks, and input the data output from the last decoder block among the plurality of decoder blocks to the multi-perceptron layer.

In addition, the learning system 100 may input the plurality of training feature maps generated at different scales from each of the plurality of encoder blocks included in the image encoder to the feature map fusion block, and synthesize (or connect) the data output from the feature map fusion block and the data output from the multi-perceptron layer to generate the training mask.

In this case, the learning system 100 may input the training mask generated before the grasp header to generate the training grasp map corresponding to the training mask.

The learning system 100 according to the present invention may compare the ground-truth data, the training mask, and the training grasp map to calculate the loss function, and train at least one of the image encoder, the prompt encoder, and the mask decoder based on the loss function (S400).

Specifically, as illustrated in FIG. 5, the learning system 100 may compare a ground-truth mask 17 included in the ground-truth data 15 with a training mask 27 to calculate the mask loss, compare a ground-truth grasp map 18 included in the ground-truth data 15 with a training grasp map 28 to calculate the grasp loss, add up the mask loss and the grasp loss to calculate a loss function 29, and train at least one of the image encoder 21, the prompt encoder 23, and the mask decoder 25 based on the calculated loss function 29.

In this case, the learning system 100 may fix the parameters of the plurality of encoder blocks for the image encoder 21 composed of the plurality of encoder blocks and the adapter provided in each of the plurality of encoder blocks, train the adapter based on the previously calculated loss function 29, fix the parameters of the plurality of decoder blocks for the mask decoder 25 composed of the plurality of decoder blocks, the feature map fusion block, the multi-perceptron layer, and the grasp header, and train the feature map fusion block, the multi-perceptron layer, and the grasp header based on the previously calculated loss function 29.

In this regard, the learning system 100 may assign weights to each of the mask loss and the grasp loss to calculate the loss function 29. In this case, the learning system 100 may assign a greater weight to the mask loss than to the grasp loss.

In addition, the learning system 100 may divide the grasp loss into a mask area loss and a non-mask area loss based on the training mask 27. In this case, the mask area loss may be a loss calculated for an area corresponding to the training mask 27 in the training grasp map 28, and the non-mask area loss may be a loss calculated for an area not corresponding to the training mask 27 in the training grasp map 28.

Accordingly, the learning system 100 may assign weights to each of the mask area loss and the non-mask area loss to calculate the grasp loss. In this case, the learning system 100 may assign a greater weight to the mask area loss than to the non-mask area loss.

Referring to FIG. 6, the system 200 for generating a grasp map according to the present invention may receive the prompt generated to specify the target object together with the image in which the target object is captured (S500).

Specifically, the system 200 for generating a grasp map may receive the prompt generated to specify the target object in the image according to the user input together with the image.

For example, the system 200 for generating a grasp map may receive the prompt generated in the form of the voice or text together with the image. In this case, the prompt may include information describing the target object to be specified in the image.

For another example, the system 200 for generating a grasp map may receive the prompt generated in the form of the point together with the image. In this case, the prompt may include information indicating a specific location (or a specific pixel) on the image.

For another example, the system 200 for generating a grasp map may receive the prompt generated in the form of the bounding box or the polygonal box together with the image. In this case, the prompt may include information indicating the location (or pixel) of the bounding box or the polygonal box on the image.

The system 200 for generating a grasp map according to the present invention may extract the feature map corresponding to the image using the pre-provided image encoder (S600).

Specifically, the system 200 for generating a grasp map may input the image to the image encoder composed of the plurality of encoder blocks and the adapter provided in each of the plurality of encoder blocks to extract the feature map. In this case, the adapter may be trained by the learning system 100 according to the present invention.

Referring to FIG. 7, for example, system 200 for generating a grasp map may segment the image 31 into the image patches of the predetermined size and input the segmented image to a first encoder block 41 to generate a first feature map 71. In addition, the system 200 for generating a grasp map may input the first feature map 71 to a first adapter 46 provided in the first encoder block 41 to generate a first adapter feature map.

Accordingly, the system 200 for generating a grasp map may synthesize (or connect) the first feature map 71 and the first adapter feature map to generate a first synthesized feature map, and input the first synthesized feature map to a second encoder block 42 to generate a second feature map 72. In addition, the system 200 for generating a grasp map may input the second feature map 72 to a second adapter 47 provided in the second encoder block 42 to generate a second adapter feature map.

Therefore, the system 200 for generating a grasp map may synthesize (or connect) the second feature map 72 and the second adapter feature map to generate a second synthesized feature map, and may repeat the process of generating the feature map through the plurality of encoder blocks provided in the image encoder and the adapter provided in each encoder block to generate a multi-scale feature map 70.

In this case, the plurality of feature maps 71, 72, and 73 corresponding to the multi-scale feature map 70 may include feature maps output from the plurality of encoder blocks, and a final feature map output from the image encoder may be a feature map 73 output from the last encoder block among the plurality of encoder blocks.

Referring back to FIG. 6, the system 200 for generating a grasp map according to the present invention may input the prompt to the pre-provided prompt encoder to generate the token for the target object determined to be grasped in the image (S700).

Specifically, as illustrated in FIG. 8, the system 200 for generating a grasp map may input the prompt 33 generated to specify the target object in the image 31 according to the user input to the pre-provided prompt encoder 50 to generate a token 51 indicating the area where the target object is located in the image 31.

For example, the system 200 for generating a grasp map may input a prompt generated in the form of a point corresponding to an image to the prompt encoder. In this case, the system 200 for generating a grasp map may generate the bounding box (or the polygonal box) indicating the area of the target object based on the location where the prompt is specified on the image through the prompt encoder, and may generate the previously generated bounding box (or the parameter into which the bounding box is converted) as the token.

For another example, the system 200 for generating a grasp map may input the prompt generated in the form of the voice or text corresponding to the image to the prompt encoder. In this case, the system 200 for generating a grasp map may generate the bounding box (or the polygonal box) indicating the area of the target object on the image based on the prompt through the prompt encoder, and generate the previously generated bounding box (or the parameter into which the bounding box is converted) as the token.

For another example, the system 200 for generating a grasp map may input the prompt generated in the form of the bounding box or the polygonal box corresponding to the image to the prompt encoder. In this case, the system 200 for generating a grasp map may convert the prompt into the parameter form through the prompt encoder to generate the token.

Referring back to FIG. 6, the system 200 for generating a grasp map according to the present invention may input the feature map and the token to the pre-provided mask decoder to generate the mask indicating the area corresponding to the target object in the image and the grasp map indicating the area where the target object is graspable (S800).

Specifically, the system 200 for generating a grasp map may input the feature map generated from the image encoder and the token generated from the prompt encoder to the mask decoder composed of the plurality of decoder blocks, the feature map fusion block, the multi-perceptron layer, and the grasp header to generate the mask and the grasp map. In this case, the feature map fusion block, the multi-perceptron layer, and the grasp header may be trained by the learning system 100 according to the present invention.

Referring to FIG. 9, for example, the system 200 for generating a grasp map may input the feature map 70 generated from the last encoder block among the plurality of encoder blocks included in the image encoder and the token 51 generated from the prompt encoder to a first decoder block 61, and input data output from the first decoder block 61 to a second decoder block 62. Accordingly, the system 200 for generating a grasp map may repeat the process of inputting the data output from the previous decoder block to each of the plurality of decoder blocks.

That is, the system 200 for generating a grasp map may input the feature map 70 generated from the image encoder and the token 51 generated from the prompt encoder to the first decoder block among the plurality of decoder blocks, and input the data output from the last decoder block among the plurality of decoder blocks to the multi-perceptron layer 65.

In addition, the system 200 for generating a grasp map may input the plurality of feature maps generated at different scales from each of the plurality of encoder blocks included in the image encoder to a feature map fusion block 63, and synthesize (or connect) the data output from the feature map fusion block 63 and the data output from the multi-perceptron layer 65 to generate the mask 35.

In this case, the system 200 for generating a grasp map may input the mask 35 generated before the grasp header 67 to generate the grasp map 37 corresponding to the mask 35.

Through the above configurations, the learning system 100 and the system 200 for generating a grasp map according to the present invention may generate the grasp map for the target object based on the image and the prompt specifying the target object on the image, thereby generating a more accurate grasp map for an untrained target object.

In addition, the learning system 100 and the system 200 for generating a grasp map according to the present invention may mount the modules such as the learnable adapter and the multi-perceptron layer on the encoder and the decoder that have been pre-trained based on the large-scale training data and learning only the corresponding modules, thereby omitting the complex and resource-intensive learning process and performing the efficient adaptation process to perform the effective grasp map estimation.

Furthermore, the system 200 for generating a grasp map and the learning system 100 according to the present invention may be implemented through a computing device described below and may perform the data processing related to at least one of the above-described grasp map generation method and learning method.

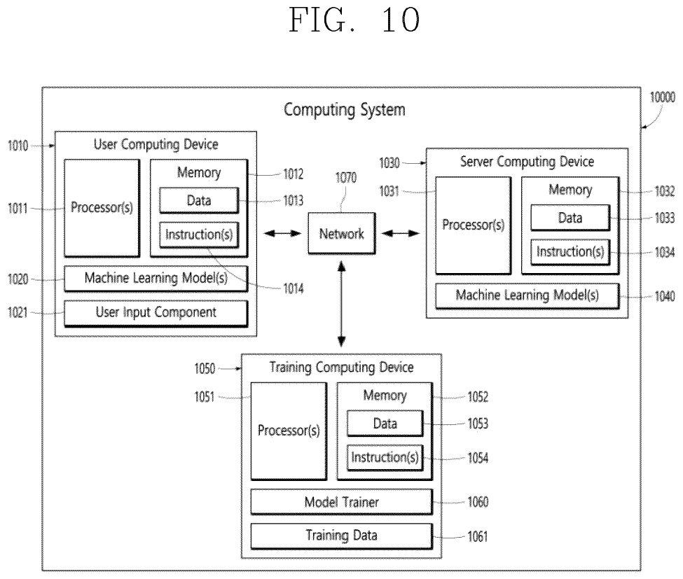

FIG. 10 illustrates an example block diagram of a computing system in which the present invention may be implemented.

Referring to FIG. 10, a computing system (10000) for performing a method for generating a grasp map based on object segmentation and learning method according to an embodiment of the present invention may include at least one computing device. In this case, the at least one computing device may be a single-processor or multi-processor computing apparatus.

The components of the at least one computing device of the present invention may include one or more processors, memory, other hardware, and various system components connected (e.g., communicatively, physically, or electrically connected) via a system bus (not shown) that enables data to be transmitted and received among them. The components of the at least one computing device are not limited thereto and may vary widely.

Meanwhile, the at least one computing device included in the computing system (10000) that performs a method for generating a grasp map based on object segmentation and learning method may be communicatively connected via a network (1070). For example, the at least one computing device included in the computing system (10000) may be clustered or may be part of a local area network (LAN). Additionally, the at least one computing device may be part of a wide area network (WAN) or connected via at least one of a client-server network or a peer-to-peer network in a cloud environment.

Meanwhile, when the at least one computing device is used in at least one environment among a network environment and a cloud computing environment, the at least one computing device may be connected to at least one of a public network and a private network through a network interface or adapter. In an embodiment, other communication connection devices, such as a modem, may be used to establish communication over the network. The modem may be at least one of an internal modem and an external modem, and may be connected to the system bus through a network interface or a specific mechanism. A wireless network component comprising an interface and an antenna may be coupled to the network through devices such as access points or peer computers. In the present invention, the method by which the at least one computing device is communicatively connected via the network (1070) is not limited thereto and may be implemented by means other than the examples described above.

Furthermore, other computer-type devices and/or systems not illustrated in FIG. 10 may technically interact with the at least one computing device or other systems through one or more connections to the network (1070) via a network interface. Here, the network interface may include network interface equipment such as a physical Network Interface Controller (NIC) or a Virtual Interface (VIF).

The network (1070) of the present invention may include various types of networks such as the Internet, Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), 5th Generation Mobile Telecommunication (5G), Bluetooth™, Radio Frequency Identification (RFID), Infrared Data Association (IrDA), Ultra-Wideband (UWB), ZigBee, Near Field Communication (NFC), Wireless Universal Serial Bus (Wireless USB), and the like. In the present invention, data transmission may be performed based on standard communication protocols such as TCP/IP, HTTP, SSL, and others.

The computing system (10000) for performing a method for generating a grasp map based on object segmentation and learning method according to the present invention may include at least one of a user computing device (1010), a training computing device (1050), and a server computing device (1030).

The user computing device (1010) according to the present invention may be understood as a computing device including at least one processor (1011) and memory (1012) for performing a method for generating a grasp map based on object segmentation and learning method. For example, the user computing device (1010) may include at least one computing device selected from among a smart phone, smart TV, laptop computer, desktop computer, digital broadcasting terminal, personal digital assistant (PDA), portable multimedia player (PMP), navigation device, slate PC, tablet PC, ultrabook, and wearable device (e.g., smartwatch, smart glass, and head-mounted display (HMD)).

The at least one processor (1011) constituting the user computing device (1010) may include one or more general-purpose processors and/or one or more special-purpose processors. For example, the at least one processor (1011) of the user computing device (1010) may include at least one or a combination of electrically connected processors selected from the group consisting of: a Central Processing Unit (CPU), a Graphics Processing Unit (GPU), a Tensor Processing Unit (TPU), a Neural Processing Unit (NPU), an Arithmetic Logic Unit (ALU), a Floating Point Unit (FPU), an Application-Specific Integrated Circuit (ASIC), a digital signal processing device (DSPD), a programmable logic device (PLD), a Field Programmable Gate Array (FPGA), a controller, a microcontroller, a microprocessor, and other electrical units for performing specific functions.

Furthermore, the at least one processor (1011) may be configured to execute computer-readable instructions stored in the memory (1012) and/or other commands described in the present specification.

The memory (1012) constituting the user computing device (1010) according to the present invention may include volatile memory, non-volatile memory, fixed media, removable media, magnetic media, optical media, semiconductor media, and/or other types of physically durable storage media.

For example, the memory (1012) may include one or more non-transitory/transitory computer-readable storage media, or combinations thereof, such as Random Access Memory (RAM), Read Only Memory (ROM), Hard Disk Drive (HDD), Solid State Disk (SSD), Silicon Disk Drive (SDD), Electrically Erasable Programmable Read-Only Memory (EEPROM), Erasable Programmable Read-Only Memory (EPROM), flash memory devices, and magnetic disks. It may also include web storage of a server that performs the memory storage function over the Internet.

The memory (1012) may store data and instructions necessary for the at least one processor (1011) to perform operations of an application for generating a grasp map based on object segmentation and learning.

The user computing device (1010) may include one or more user input components (1021) configured to detect user input. For example, the user input component (1021) may also be referred to as a user interface module. The user input component (1021) may include devices such as a touchscreen, computer mouse, keyboard, keypad, touchpad, trackball, joystick, voice recognition module, or other similar devices. However, the present invention does not limit the types of the user input component (1021).

In this context, the user input component (1021) in the present invention is not necessarily limited to a hardware means but may be understood as a channel through which input is received from a user.

Meanwhile, the “user” in the present invention may also refer to an automated agent, script, playback software, or the like that operates on behalf of one or more human users.

A user may interact with the computing system (10000), which includes at least one computing device, through the user input component (1021) using inputted text, touch, voice, motion, computer vision, gesture, and/or other forms of input/output. For example, the user input component (1021) may include one or more user interface (UI) modalities such as a Command Line Interface (CLI), Graphical User Interface (GUI), Natural User Interface (NUI), voice command interface, and/or other UI representations.

One or more Application Programming Interface (API) calls may be made between the user input component (1021) and the user computing device (1010), based on user input received through a user interface and/or from a network.

Herein, the phrase “based on” may be interpreted to include instances where a particular configuration is used as a foundation, modified from, derived from, influenced by, dependent on, or otherwise originating from such configuration.

In some embodiments, the API call may be configured for a specific API and may be interpreted as, or converted into, an API call configured for a different API. In this context, the API may refer to a defined interface or connection between computers or between computer programs.

In an embodiment, the user computing device (1010) may store one or more machine learning models (1020). For example, the user computing device (1010) may include various machine learning models, such as multiple neural networks (e.g., deep neural networks) for performing generation and learning of a grasp map based on object segmentation using a prompt generated to specify a target object along with an image of the target object, or other types of machine learning models including nonlinear models and/or linear models, or may be configured as a combination thereof.

According to an embodiment of the present invention, the user computing device (1010) may perform a method for generating a grasp map based on object segmentation and learning method by using a local and/or external machine learning model (1020). Alternatively, the user computing device (1010) may perform the method for generating a grasp map based on object segmentation and learning method by using a machine learning model (1040) provided by a server.

According to another embodiment of the present invention, a server computing device (1030) communicating with the user computing device (1010) may provide a grasp map indicating graspable regions of a target object to the user computing device (1010) via an application and/or a web interface, in response to a user request received through the user computing device (1010).

According to yet another embodiment of the present invention, at least a portion of the user computing device (1010) and the server computing device (1030) may be cooperatively operated to perform a method for generating a grasp map based on object segmentation and learning method, thereby providing a grasp map indicating graspable regions of the target object to the user.

According to various embodiments of the present invention, the user computing device (1010) and/or the server computing device (1030) may train the machine learning models (1020, 1040) used in the method for generating a grasp map based on object segmentation and learning method through interaction with a training computing device (1050) that is communicatively connected via the network (1070).

In this case, the training computing device (1050) may be a computing system separate from the server computing device (1030). Alternatively, in some embodiments, the training computing device (1050) may be a part of the server computing device (1030) or a part of the user computing device (1010).

Meanwhile, the server computing device (1030) may include at least one processor (1031) and memory (1032). Here, the processor (1031) may include at least one or a combination of electrically connected processors selected from among: a Central Processing Unit (CPU), Graphics Processing Unit (GPU), Tensor Processing Unit (TPU), Neural Processing Unit (NPU), Application-Specific Integrated Circuit (ASIC), Arithmetic Logic Unit (ALU), Floating Point Unit (FPU), digital signal processing devices (DSPDs), programmable logic devices (PLDs), Field Programmable Gate Arrays (FPGAs), controllers, microcontrollers, microprocessors, and/or other electrical units for performing specific functions. For example, the at least one processor (1031) may include circuits and transistors configured to execute instructions from the memory (1032).

The memory (1032) constituting the server computing device (1030) according to the present invention may include volatile memory, non-volatile memory, fixed media, removable media, magnetic media, optical media, semiconductor media, and/or other types of physically durable storage media.

For example, the memory (1032) may include one or more transitory/non-transitory computer-readable storage media, or combinations thereof, such as Random Access Memory (RAM), Read Only Memory (ROM), Hard Disk Drive (HDD), Solid State Disk (SSD), Silicon Disk Drive (SDD), Electrically Erasable Programmable Read-Only Memory (EEPROM), Erasable Programmable Read-Only Memory (EPROM), flash memory devices, and magnetic disks. It may also include web storage of a server that performs memory storage functions over the Internet.

Additionally, the server computing device (1030) may further include a data store. For example, the data store may be configured as at least one of a relational database, a NoSQL database, a data warehouse, and a local file system.

The memory (1032) constituting the server computing device (1030) according to the present invention may store data and instructions necessary for the at least one processor (1031) to perform operations of an application for generating a grasp map based on object segmentation and learning.

In an embodiment, the server computing device (1030) may be configured as a single device or as a plurality of computing devices, which may be configured to operate according to a sequential or parallel computing architecture. Additionally, the system may be implemented as a distributed processing system comprising multiple devices connected over a network.

Meanwhile, the training computing device (1050) may include at least one processor (1051) and memory (1052). A model trainer (1060), as a logical component that performs training of at least one machine learning model (1020, 1040), may be implemented in the form of hardware, firmware, or software.

For example, the model trainer (1060) may load training data (1061) stored in a storage device into the memory (1052), and then be executed by the processor (1051). The model trainer (1060) may be configured to perform one or more operations-such as model training, model reconstruction, model validation, and model testing-on at least one machine learning model.

The machine learning model according to the present invention may include at least one of the following: a statistical model, an algorithm, a neural network (NN), a convolutional neural network (CNN), a generative neural network (GNN), a Word2Vec model, a Bag of Words model, a Term Frequency-Inverse Document Frequency (TF-IDF) model, a Generative Pre-trained Transformer (GPT) model (or other autoregressive models), a Proximal Policy Optimization (PPO) model, a nearest neighbor model (e.g., k-nearest neighbor model), a linear regression model, a k-means clustering model, a Q-learning model, a Temporal Difference (TD) model, a Deep Adversarial Network model, and any other type of model described in the present specification.

Specifically, the model trainer (1060) may perform operations for training a machine learning model, and the operations may include at least one of adding, removing, and modifying 39 of43 model parameters. In this case, the training of the machine learning model may be at least one of supervised learning, semi-supervised learning, and unsupervised learning.

In an embodiment, training of the machine learning model may include a step of repeatedly inputting the training data (1061) based on epochs, and iteratively performing the machine learning model learning process configured in this manner. Here, an epoch may refer to a unit representing one complete forward and backward pass of the entire training data (1061) set.

In some implementations, different learning methods (e.g., supervised learning, semi-supervised learning, and unsupervised learning) may be applied at different epochs.

The training data (1061) of the present invention may include input data and/or data previously output from at least one machine learning model (e.g., recursive learning feedback).

The parameters of the at least one machine learning model may include at least one of a seed value, model nodes, model layers, algorithms, functions, connections between different machine learning models, connections between parameters, constraints of the machine learning model, and other digital components that influence the output of the machine learning model.

In this case, a model connection between different machine learning models may include or represent relationships between model parameters and/or between models, which may be dependent, interdependent, hierarchical, and/or static or dynamic.

The combination and configuration of the model parameters described herein may be too complex to be maintained or utilized by human cognitive capabilities.

The present invention does not limit the parameters of machine learning models to those described in the embodiments, and a single machine learning model may include a plurality of model parameters.

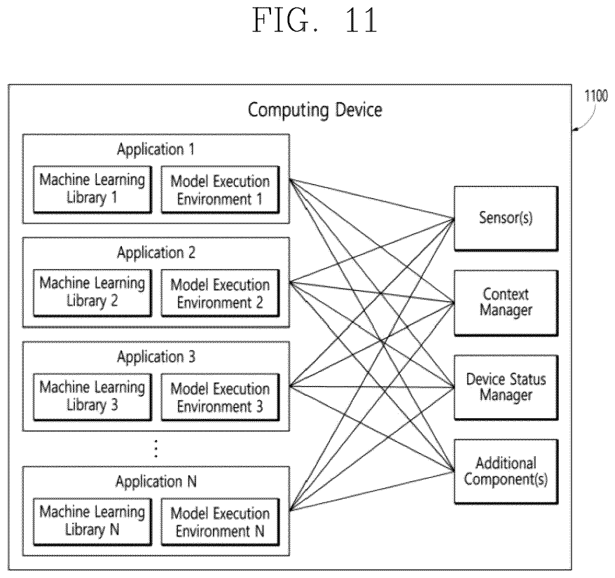

Meanwhile, FIG. 11 illustrates an example block diagram of a computing device (1100), which may be included in the user computing device (1010), the server computing device (1030), or the training computing device (1050), as an embodiment of the computing system (10000) in which the present invention may be implemented.

As shown in FIG. 11, the computing device (1100) may include at least one application (e.g., Application 1 to Application N), and each of the at least one application may include a machine learning library and a model execution environment for performing a method for generating a grasp map based on object segmentation and learning method using machine learning.

Each of the at least one application included in the computing device (1100) may communicate via an Application Programming Interface (API) with one or more components within the computing device (1100), such as sensors, a context manager, a device state manager, or additional components.

In an embodiment, the at least one application may interface with device components by, for example, receiving sensor data or state data via a public or dedicated API, or transmitting prediction results to an output device.

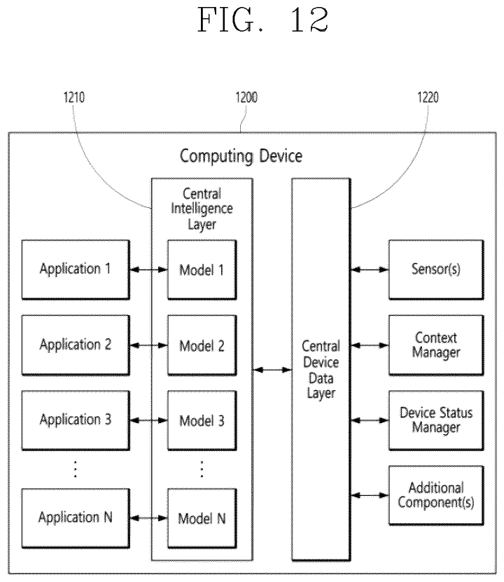

Meanwhile, FIG. 12 illustrates an example block diagram of a computing device (1200), which is one component of the computing system (10000) performing the method for generating a grasp map based on object segmentation and learning method according to an embodiment of the present invention, from another perspective.

The computing device (1200) according to the present invention may include at least one application (e.g., Application 1 to Application N), and each of the at least one application may communicate with a central intelligence layer (1210). Each application may interact with a shared model within the central intelligence layer (1210) via an API (e.g., a common API).

The central intelligence layer (1210) may include one or more machine learning models and may either share them among multiple applications or provide them independently to each application. In an embodiment, the central intelligence layer (1210) may be integrated as part of the operating system or implemented as a separate logical layer.

Additionally, the central intelligence layer (1210) may communicate with a central device data layer (1220). The central device data layer (1220) may integratively store images of target objects captured and stored within the computing device (1200) and provide them as input data required for generating a grasp map based on object segmentation and learning. Each device component (e.g., sensors, state managers, etc.) may communicate with the central device data layer (1220) via a private API or the like.

The technology described in the present specification may be implemented using a single computing device or multiple computing devices. A machine learning model for performing a method for generating a grasp map based on object segmentation and learning method may be executed sequentially or in parallel on a single component or across multiple distributed components. The data store, machine learning models, and applications may be distributed and operated locally or over a network, and these components may be flexibly applied to various system architectures.

Meanwhile, the learning system 100 and the system 200 for generating a grasp map of the present invention have been described above as being implemented as a computing system, but the present invention is not limited thereto. For example, the functions of the neural network and/or the computing device may be distributed among a plurality of computing clusters.

In addition, the present invention described above may be implemented as a program that is executed by one or more processes in the electronic device and stored in the computer-readable recording medium.

Therefore, the present invention can be implemented as a computer-readable code or instruction in the medium in which the program is recorded. That is, various control methods according to the present invention may be provided in the form of an integrated or individual program.

Meanwhile, the computer-readable medium includes all types of recording devices in which data that can be read by the computer system is stored. An example of the computer-readable medium may include a hard disk drive (HDD), a solid state disk (SSD), a silicon disk drive (SDD), a ROM, a RAM, a CD-ROM, a magnetic tape, a floppy disk, an optical data storage device, etc.

Furthermore, the computer-readable medium may be a server or cloud storage that includes storage and that the electronic device may access through communication. In this case, the computer may download the program according to the present invention from the server or cloud storage through wired or wireless communication.

Furthermore, in the present invention, the computer described above is an electronic device equipped with a processor, that is, a central processing unit (CPU), and there is no particular limitation on its type.

Meanwhile, the above-described detailed description is to be interpreted as being illustrative rather than being restrictive in all aspects. The scope of the present invention is to be determined by reasonable interpretation of the claims, and all modifications within an equivalent range of the present invention fall in the scope of the present invention.

What is claimed is:

1. A method processed by a computing device for generating a grasp map, comprising:
receiving a prompt generated to specify a target object together with an image obtained by capturing the target object;
extracting a feature map corresponding to the image using a pre-provided image encoder;
inputting the prompt to a pre-provided prompt encoder to generate a token for the target object determined to be grasped in the image; and
inputting the feature map and the token to a pre-provided mask decoder to generate a mask indicating an area corresponding to the target object in the image and a grasp map indicating an area where the target object is graspable.

2. The method of claim 1, wherein the image encoder is composed of a plurality of encoder blocks and an adapter provided in each of the plurality of encoder blocks, and
the mask decoder is composed of a plurality of decoder blocks, a feature map fusion block, a multi-perceptron layer, and a grasp header.

3. The method of claim 2, wherein the generating of the grasp map includes:
inputting a feature map generated from the image encoder and a token generated from the prompt encoder to a first decoder block among the plurality of decoder blocks;
inputting data output from a last decoder block among the plurality of decoder blocks to the multi-perceptron layer;
inputting a plurality of feature maps generated at different scales from each of the plurality of encoder blocks included in the image encoder to the feature map fusion block;
generating the mask by synthesizing data output from the feature map fusion block and data output from the multi-perceptron layer; and
inputting the generated mask to the grasp header to generate a grasp map corresponding to the mask.

4. The method of claim 1, further comprising a training step,
wherein the training step comprises:
receiving a training image, a training prompt, and ground-truth data;
extracting a training feature map corresponding to the training image using the pre-provided image encoder, and inputting the training prompt to the pre-provided prompt encoder to generate a training token for a target object determined to be grasped in the training image;
inputting the training feature map and the training token to the pre-provided mask decoder to generate a training mask indicating an area corresponding to the target object in the training image and a training grasp map indicating an area where the target object is graspable; and
comparing the ground-truth data, the training mask, and the training grasp map to calculate a loss function, and training at least one of the image encoder, the prompt encoder, and the mask decoder based on the loss function.

5. The method of claim 4, wherein the training includes:
comparing a ground-truth mask included in the ground-truth data with the training mask to calculate a mask loss;
comparing a ground-truth grasp map included in the ground-truth data with the training grasp map to calculate a grasp loss;
adding up the mask loss and the grasp loss to calculate the loss function; and
training at least one of the image encoder, the prompt encoder, and the mask decoder based on the calculated loss function.

6. The method of claim 4, wherein, in the training, for the image encoder composed of a plurality of encoder blocks and an adapter provided in each of the plurality of encoder blocks, parameters of the plurality of encoder blocks are fixed and the adapter is trained based on the calculated loss function, and
for the mask decoder composed of a plurality of decoder blocks, a feature map fusion block, a multi-perceptron layer, and a grasp header, parameters of the plurality of decoder blocks are fixed and the feature map fusion block, the multi-perceptron layer, and the grasp header are trained based on the calculated loss function.

7. A system for generating a grasp map, comprising:
a storage unit that stores a prompt generated to specify a target object together with an image obtained by capturing the target object;
a control unit that generates a grasp map corresponding to the image and the prompt using an image encoder, a prompt encoder, and a mask decoder, and
the control unit extracts a feature map corresponding to the image using the image encoder, inputs the prompt to the prompt encoder to generate a token for the target object determined to be grasped in the image, and inputs the feature map and the token to the mask decoder to generate a mask indicating an area corresponding to the target object in the image and a grasp map indicating an area where the target object is graspable.

8. The system of claim 7,
wherein the image encoder comprises a plurality of encoder blocks and an adapter provided in each of the plurality of encoder blocks, and
wherein the mask decoder comprises a plurality of decoder blocks, a feature map fusion block, a multi-perceptron layer, and a grasp header.

9. The system of claim 8,
wherein the control unit is configured to generate the grasp map by:
inputting a feature map generated from the image encoder and a token generated from the prompt encoder to a first decoder block among the plurality of decoder blocks;
inputting data output from a last decoder block among the plurality of decoder blocks to the multi-perceptron layer;
inputting a plurality of feature maps generated at different scales from each of the plurality of encoder blocks included in the image encoder to the feature map fusion block;
generating the mask by synthesizing data output from the feature map fusion block and data output from the multi-perceptron layer; and
inputting the generated mask to the grasp header to generate the grasp map corresponding to the mask.

10. The system of claim 7,
wherein the control unit is further configured to perform training by:
receiving a training image, a training prompt, and ground-truth data;
extracting a training feature map corresponding to the training image using the image encoder, and inputting the training prompt to the prompt encoder to generate a training token for a target object determined to be grasped in the training image;
inputting the training feature map and the training token to the mask decoder to generate a training mask indicating an area corresponding to the target object in the training image and a training grasp map indicating an area where the target object is graspable; and
comparing the ground-truth data, the training mask, and the training grasp map to calculate a loss function, and training at least one of the image encoder, the prompt encoder, and the mask decoder based on the loss function.

11. The system of claim 10,
wherein the control unit is configured to train by:
comparing a ground-truth mask included in the ground-truth data with the training mask to calculate a mask loss;
comparing a ground-truth grasp map included in the ground-truth data with the training grasp map to calculate a grasp loss;
adding up the mask loss and the grasp loss to calculate the loss function; and
training at least one of the image encoder, the prompt encoder, and the mask decoder based on the calculated loss function.

12. The system of claim 10,
wherein, in the training, for the image encoder comprising a plurality of encoder blocks and an adapter provided in each of the plurality of encoder blocks, parameters of the plurality of encoder blocks are fixed and the adapter is trained based on the calculated loss function, and
for the mask decoder comprising a plurality of decoder blocks, a feature map fusion block, a multi-perceptron layer, and a grasp header, parameters of the plurality of decoder blocks are fixed and the feature map fusion block, the multi-perceptron layer, and the grasp header are trained based on the calculated loss function.

13. A learning method processed by a computing device, comprising:
receiving a training image, a training prompt, and ground-truth data;
extracting a training feature map corresponding to the training image using a pre-provided image encoder, and inputting the training prompt to a pre-provided prompt encoder to generate a training token for a target object determined to be grasped in the training image;
inputting the training feature map and the training token to a pre-provided mask decoder to generate a training mask indicating an area corresponding to the target object in the training image and a training grasp map indicating an area where the target object is graspable; and
comparing the ground-truth data, the training mask, and the training grasp map to calculate a loss function, and training at least one of the image encoder, the prompt encoder, and the mask decoder based on the loss function.

14. The learning method of claim 13, wherein the training includes:
comparing a ground-truth mask included in the ground-truth data with the training mask to calculate a mask loss;
comparing a ground-truth grasp map included in the ground-truth data with the training grasp map to calculate a grasp loss;
adding up the mask loss and the grasp loss to calculate the loss function; and
training at least one of the image encoder, the prompt encoder, and the mask decoder based on the calculated loss function.

15. The learning method of claim 14, wherein, in the training, for the image encoder composed of a plurality of encoder blocks and an adapter provided in each of the plurality of encoder blocks, parameters of the plurality of encoder blocks are fixed and the adapter is trained based on the calculated loss function, and
for the mask decoder composed of a plurality of decoder blocks, a feature map fusion block, a multi-perceptron layer, and a grasp header, parameters of the plurality of decoder blocks are fixed and the feature map fusion block, the multi-perceptron layer, and the grasp header are trained based on the calculated loss function.
